(19) United States
(12) Patent Application Publication
(10) Pub. No.: US 2023/0263226 A1
(43) Pub. Date: Aug. 24, 2023

(54) Heater Device Component

(71) Applicant: JT International SA, Geneva (CH)

(72) Inventors: Kyle Adair, Lisburn (GB); Alec Wright, Guildford (GB); Andrew Robert John Rogan, Forres (GB); Olayiwola Olamiposi Popoola, Walton-on-Thames (GB); Gordon Montgomery, Ballymena (GB)

(73) Assignee: JT International SA, Geneva (CH)

(21) Appl. No.: 18/017,959

(22) PCT Filed: Jul. 27, 2021
(86) PCT No.: PCT/EP2021/071021

§ 371 Date: Jan. 25, 2023

(30) Foreign Application Priority Data
Jul. 29, 2020 (EP) 20188458.2

(51) Int. Cl. A24F 40/46; H05B 3/42; A24F 40/10; A24F 40/48; A24F 7/00

(52) U.S. Cl. CPC A24F 40/46; H05B 3/42; A24F 40/10; A24F 40/48; A24F 7/00; H05B 2203/021

(57) ABSTRACT

A heater device for an electronic cigarette comprises: a heater unit arranged to vaporise a liquid received from a liquid reservoir and generate a vapour; and a vapour flow path extending from the heater unit and arranged to fluidly communicate with a mouthpiece of an electronic cigarette to allow the generated vapour to flow from the heater unit to the mouthpiece. The heater unit comprises a plurality of through-channels arranged to allow the generated vapour to flow from the heater unit to the vapour flow path. The plurality of through-channels comprises at least two primary through-channels and at least two secondary through-channels, where a diameter of a primary through-channel is different than a diameter of a secondary through-channel. The plurality of through-channels are arranged such that the at least two primary through-channels are alternately arranged with the secondary through-channels.

### FIELD OF INVENTION

The present invention relates to vapour generation devices, and more specifically heaters for vapour generation devices.

### BACKGROUND

Vapour generating devices, such as electronic cigarettes, are becoming increasingly popular consumer products.

Heating devices for vaporisation or aerosolisation are known in the art. Such devices typically include a heater arranged to heat a vaporisable product. In operation, the vaporisable product is heated with the heater to vaporise the constituents of the product for the consumer to inhale. In some examples, the product may comprise tobacco in a capsule or may be similar to a traditional cigarette, in other examples the product may be a liquid, or liquid contents in a capsule.

There is a need to improve the experience of the consumer of such products; an object of the present invention is to address this need by improving the quality of the vapour flow. There is also a need to improve heater operation; another object of the invention is to address this.

### SUMMARY

According to a first aspect there is provided a heater device for an electronic cigarette comprising a heater unit arranged to vaporise a liquid received from a liquid reservoir and generate a vapour. A vapour flow path extends from the heater unit arranged to fluidly communicate with a mouthpiece of an electronic cigarette to allow the generated vapour to flow from the heater unit to the mouthpiece. The heater unit comprises a plurality of through-channels arranged to allow the generated vapour to flow from the heater unit to the vapour flow path. The plurality of through-channels comprises at least two primary through-channels and at least two secondary through-channels and a diameter of a primary through-channel is different to a diameter of a secondary through-channel. The plurality of through-channels are arranged such that the at least two primary through-channels are alternately arranged with the at least two secondary through-channels.

The different through-channels sizes, namely the primary and secondary through-channels, can selectively pass liquids with different surface tensions from the reservoir through the heater unit via the through-channels. By using a heater unit having through-channels with different diameters, the same heater unit can be used to vaporise a greater variety of liquids having different surface tensions. Thus, a wider variety of liquid surface tensions can be used with a single heater device, making the heater device more efficient.

Providing an alternate arrangement of primary and secondary through-channels means that the liquid will be more evenly distributed through the heater unit. This may result in a more consistent vapour flow which may improve the user experience.

Preferably, the plurality of through-channels form part of the vapour flow path. This provides a more simple construction has the generated vapour is able to pass directly from the heater unit to the vapour flow path. Reducing the number of components through which the vapour has to travel reduces the chance of leakage.

The plurality of through-channels may act as a filter arranged to filter the generated vapour as it flows from the heater unit to the vapour flow path.

In some cases, the diameter of the at least two primary through-channels may be the same. That is, in some cases the diameter of all the primary through-channels may be the same.

In some cases, the diameter of the at least two secondary through-channels may be the same. That is, in some cases the diameter of all the secondary through-channels may be the same.

In other cases, the diameters of the at least two primary through-channels and the diameters of the at least two secondary through-channels may all be different from each other. That is to say, the diameters of all the primary and secondary through-channels in the plurality of through-channels may all be different from each other.

The diameter of at least one of the primary through-channels may be greater than the diameter of at least one of the secondary through-channels. Preferably, the diameter of the at least two primary through-channels is greater than the diameter of the at least two secondary through-channels.

The average diameter of the through-channels is preferably in the range between 5 micrometres and 200 micrometres, more preferably in the range between 30 micrometres and 150 micrometres, even more preferably in the range between 50 micrometres and 100 micrometres.

The average length of the through-channels is preferably in the range between 100 micrometres and 1000 micrometres, more preferably in the range between 150 micrometres and 750 micrometres, even more preferably in the range between 180 micrometres and 500 micrometres, and is for example 300 micrometres. This length may provide sufficient heating of the liquid within the through-channels.

The average distance between two through-channels is preferably at least 1.3 times the internal diameter of one of the through-channels. The distance can preferably be 1.5 to 5 times the internal diameter of the through-channel, or 2 to 4 times the internal diameter of the through-channel. This may provide a sufficiently stable arrangement and sufficient wall thickness of the through-channels.

The heater unit may comprise a capillary portion and a heating surface. The capillary portion may be located between the liquid reservoir and the heating surface and may be arranged to transfer liquid from the liquid reservoir to the heating surface. The heating surface may be arranged to heat the received liquid and generate a vapour.

Preferably, the plurality of through-channels form part of the heating surface. This configuration provides more efficient heating of the liquid as it travels through the through-channels. The liquid may also be heated for longer as it travels through the through-channels, which may help reduce the surface tension of the liquid, allowing it to travel through the through-channels, and further helping generating a vapour from the liquid.

Preferably, the plurality of through-channels are arranged across substantially the entire heating surface. This means that substantially the entire heating surface may be providing heat to the liquid. This configuration may result in more even vaporisation of the liquid which may help to generate a more consistent vapour flow, improving the user experience.

In some examples, the plurality of through-channels may be arranged in a regular pattern on a surface of the heating unit. In particular, the plurality of through-channels may be arranged in a regular pattern on the heating surface.

In other examples, the plurality of through-channels may be arranged in an irregular pattern on a surface of the heating unit. In particular, the plurality of through-channels may be arranged in an irregular pattern on the heating surface.

The shape of at least one of the primary through-channels may be the same as the shape of at least one of the secondary through-channels. In some cases the at least two primary through-channels and the at least two secondary through-channels may have the same shape. That is to say, the shapes of all the primary and secondary through-channels in the plurality of through-channels may all be the same as each other. Alternatively, the at least two primary through-channels and the at least two secondary through-channels may have different shapes. That is to say, the shapes of all the primary and secondary through-channels in the plurality of through-channels may all be different from each other.

The through-channels may be in the form of a square, rectangle, polygon, circle, oval, or other shape. For example, the at least two primary through-channels and/or the at least two secondary through-channels may substantially circular. The through-channels may be in the form of an array-arranged net.

According to another aspect, there is provided a capsule for an electronic cigarette, the capsule having a first end configured to engage with an electronic cigarette device and a second end arranged as a mouthpiece portion having a vapour outlet. The capsule further comprises a reservoir arranged to store a liquid to be vaporised, a heater unit arranged to vaporise a liquid received from the liquid reservoir and generate a vapour, and a vapour flow path extending from the heater unit arranged to fluidly communicate with a mouthpiece of an electronic cigarette to allow the generated vapour to flow from the heater unit to the mouthpiece. The heater unit comprises a plurality of through-channels arranged to allow the generated vapour to flow from the heater unit to the vapour flow path. The plurality of through-channels comprises at least two primary through-channels and at least two secondary through-channels, and further wherein a diameter of a primary through-channel is different to a diameter of a secondary through-channel. The plurality of through-channels are arranged such that the at least two primary through-channels are alternately arranged with the at least two secondary through-channels.

There may be provided a capsule for use with a vapour generating device, the capsule comprising the heater device, and any of its modifications, as described herein. In this way, the heater device can form part of a consumable capsule and can be replaceable in a vapour generation device. In particular, this can be beneficial when changing to a vaporisable substance of a different flavour, in a new capsule, as a new heater unit would be used and the generated vapour would not be contaminated with residual flavouring from the previous vaporisable substance.

According to another aspect there is provided an electronic cigarette comprising a main body and a capsule wherein the main body comprises a power supply unit, electrical circuitry, and a capsule seating configured to connect with the capsule. The capsule comprises a first end configured to engage with the electronic cigarette device and a second end arranged as a mouthpiece portion having a vapour outlet. The capsule further comprises a reservoir arranged to store a liquid to be vaporised, a heater unit arranged to vaporise a liquid received from the liquid reservoir and generate a vapour, and a vapour flow path extending from the heater unit arranged to fluidly communicate with a mouthpiece of an electronic cigarette to allow the generated vapour to flow from the heater unit to the mouthpiece. The heater unit comprises a plurality of through-channels arranged to allow the generated vapour to flow from the heater unit to the vapour flow path. The plurality of through-channels comprises at least two primary through-channel and at least two secondary through-channel, and further wherein a diameter of a primary through-channel is different to a diameter of a secondary through-channel. The plurality of through-channels are arranged such that the at least two primary through-channels are alternately arranged with the at least two secondary through-channels.

There may be provided a vapour generating device comprising the heater device, and any of its modifications, as described herein.

### BRIEF DESCRIPTION OF DRAWINGS

Embodiments of the invention are now described, by way of example, with reference to the drawings, in which:

FIG. 1 is a conceptual cross-sectional view of a portion of a vaporisation component for a vapour generation device;

FIG. 2 is a conceptual cross-sectional view of a vaporisation component integrated into a portion of a vapour generation device;

FIG. 3 is a top down view of a portion of a vaporisation component for a vapour generation device; and

FIG. 4 is another top down view of a portion of a vaporisation component for a vapour generation device.

### DETAILED DESCRIPTION

A vapour generation device is a device arranged to heat a vapour generating product to produce a vapour for inhalation by a consumer. In a specific example, a vapour generating product can be a liquid which forms a vapour when heated by the vapour generation device. A vapour generation device can also be referred to as an electronic cigarette or aerosol generation device. In the context of the present disclosure, the terms vapour and aerosol can be used interchangeably. A vapour generating product, or aerosol generating product, can be a liquid or a solid such as a fibrous material, or a combination thereof, that when heated generates a vapour or aerosol.

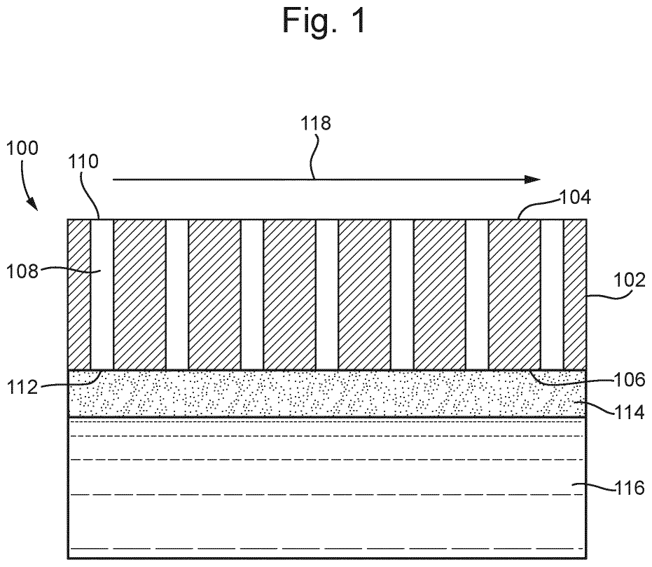

FIG. 1 shows a cross-sectional diagram of a portion of a vaporisation component 100 for a vapour generation device. In this case, the vaporisation component 100 is a heater device 100.

The vaporisation component 100 comprises an evaporator component 102, arranged to vaporise a received liquid and generate a vapour, and a vapour flow path 128 arranged to fluidly communicate with a mouthpiece of the vapour generation device to allow the generated vapour to flow from the evaporator component 102 to the mouthpiece. The evaporator component 102 may also be referred to as a heater unit 102.

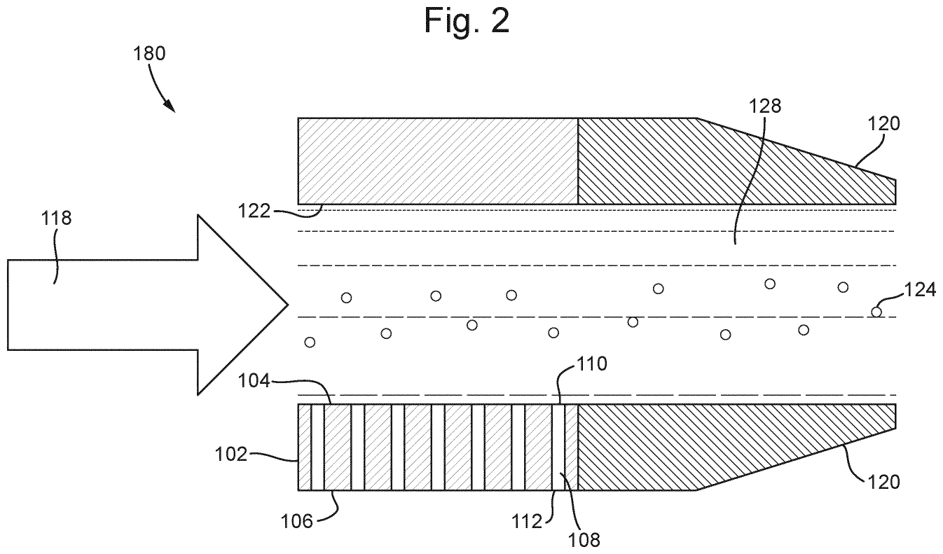

The heater device 100 is in fluid communication with a reservoir which is arranged to store a liquid vapour generating product. The evaporator component 102 (hereinafter referred to as the heater unit) can be considered as an evaporator block or heater, and in an example can be formed from silicon. FIG. 2 shows a conceptual cross-sectional diagram of the heater unit 102 integrated into a portion 180 of a vapour generation device.

The heater unit 102 has a first surface 104 that faces toward the vapour flow path 128 of the vapour generation device. The vapour flow path, which may also be referred to as an airflow channel 128 of the vapour generation device, is a channel through which air flows substantially in a direction 118 towards the mouthpiece 120 when a consumer draws upon the mouthpiece 120. In other words, the airflow channel 128 connects air inlets (not shown) within the vapour generation device to the mouthpiece 120 for the passage of air through the vapour generation device. The airflow channel 128 is arranged to transport generated vapour to the mouthpiece 120 through which the vapour is inhaled by a user. The first surface 104 of the heater unit 102 can be arranged in the airflow channel 128, and in the example of FIGS. 1 and 2 can form a portion of an internal sidewall of the airflow channel 128. The cross-section of FIGS. 1 and 2 are viewed along a direction perpendicular to the direction along the airflow channel 128 toward the mouthpiece 120.

The heater unit 102 has a second surface 106 on a separate face to the first surface 104. In the example of FIGS. 1 and 2 the second surface 106 is spaced apart from the first surface 104, on an opposing face to the first surface 104. The second surface 106 of the heater unit 102 is arranged to be in fluid communication with the reservoir 116.

A plurality of channels 108 are arranged through the heater unit 102 to connect a set of first openings 110 in the first surface 104 to a corresponding set of second openings 112 in the second surface 106. That is, each of these channels 108 is a through-hole that passes through the heater unit 102, and so the channels 108 may also be referred to as through-channels 108. The through-channels are arranged such that one end of each through-channel 108 forms a first opening 110 in the first surface 104 and the other end of each through-channel 108 forms a second opening 112 in the second surface 106. These through-channels 108 can be in an array type arrangement and of micrometre scale, as will be discussed in more detail later.

The through-channels 108 are arranged to draw liquid from the reservoir 116 through the second openings 112, through the through-channels 108, and to the first openings 110 by capillary force.

Any suitable number of through-channels 108, with corresponding numbers of first 110 and second openings 112, can be arranged in the heat unit 102. In some examples there may be at least four through-channels 108.

In some examples, an optional wicking material 114 can be incorporated into the vaporisation component 100, and in particular can be arranged between the second surface 106 of the heater unit 102 and the reservoir 116. The wicking material 114 can aid in the transfer of liquid from the reservoir 116 to the second openings 112 in the second surface 106. In this way, the reservoir 116 can either be in direct connection with the second surface 106 of the heater unit 102, or in indirect connection with the second surface 106 by way of the wicking material 114.

For clarity, only the heater unit 102 of the vaporisation component 100 is shown in FIG. 2; the reservoir 116 and optional wicking material 114 are not shown but can readily be included.

In operation, liquid is drawn from the reservoir 116 into the second openings 112 in the second surface 106 of the heater unit 102. The liquid then travels into and through the through-channels 108 by capillary action. A potential is applied to the heater unit 102 by a heater control circuit (not shown) so as to heat the heater unit 102. In turn the heater unit 102 heats the liquid through the sidewalls of the through-channels 108, as the liquid is drawn through the through-channels 108, to create a vapour. The vapour then exits the through-channels 108 as a vapour flow through the first openings 110 in the first surface 104 and enters the airflow channel 128 of the vapour generation device. This vapour flow can also include liquid droplets 124 from the through-channels 108. The through-channels 108 therefore allow the generated vapour to flow from the heater unit 102 to the airflow channel 128, and so the through-channels 108 form part of the airflow channel 128.

The second surface 106 of the heater unit 102 may therefore be thought of as a capillary potion 106. The first surface 104 of the heater unit 102 may be thought of as a heating surface. In this case, the capillary portion 106 is located between the reservoir 116 and the heating surface, and is arranged to transfer liquid from the reservoir 116 to the heating surface. The heating surface can be arranged to heat the received liquid and generate a vapour. In some cases, the sidewalls of the through-channels can be considered as being part of the first surface and thus forming part of the heating surface.

In the example of FIG. 2, the first surface 104 of the heater unit 102 partially defines an internal wall of the airflow channel 128. The airflow channel 128 can be considered as a tube or passageway, defined by internal walls, through which the air and vapour travels to the mouthpiece 120. An opposing internal wall 122 of the airflow channel is also shown in FIG. 2. The opposing internal wall 122 at least partially forms part of the internal wall of the airflow channel 128 opposite to the first surface 104 of the heater unit 102. Further internal walls, that complete the definition of the airflow channel 128, connect the first surface 104 of the heater unit 102 and the opposing wall 122. For clarity, these further internal walls are not shown in the cut-away section in FIG. 2.

When a user draws on the mouthpiece 120, air is brought into the airflow channel 128 through air inlets (not shown) connected to the airflow channel 128 and located distal from the mouthpiece 120 so as to create a pressure change that draws the generated vapour flow to the mouthpiece 120, in the airflow 118 as it passes over the first surface 104, for inhalation by the user.

For clarity, sections of the body of the vapour generation device are not shown in FIG. 2, including portions containing control electronics, a power source such as a battery, and the electronics connecting the heater unit to the control electronics and power source.

As the skilled person will appreciate, the vaporisation component described above, and any of its modifications, can be used as part of a capsule for an electronic cigarette. For example, the capsule includes a first end configured to engage with an electronic cigarette device and a second end arranged as a mouthpiece portion having a vapour outlet. The capsule also includes a reservoir arranged to store a liquid to be vaporised and the vaporisation component described above.

The vaporisation component described above, and any of its modifications, can be also used as part of an electronic cigarette. For example, an electronic cigarette comprises a main body and a capsule. The main body has a power supply, electrical circuitry, and a capsule seating. The capsule seating of the main body is arranged to engage with and electrically connect with a first end of the capsule. A second end of the capsule is arranged as a mouthpiece portion having a vapour outlet. The capsule also includes a reservoir arranged to store a liquid to be vaporised and the vaporisation component described above.

In some examples, the vaporisation component 100 of FIG. 1 includes the heater unit 102 and the reservoir 116, and optionally the wicking material 114, which can be formed as a single component. In some examples, the vaporisation component 100 is a component of the vapour generation device, with the reservoir 116 being refillable. In some examples, the vaporisation component 100 of FIG. 1 (including the heater unit 102, the reservoir 116, and optionally the wicking material 114) can be comprised in a removable capsule for the vapour generation device that can be detached from the vapour generation device (such as when the reservoir 116 is empty of liquid). In this example, the vaporisation component 100 can be a replaceable consumable. Alternatively the reservoir 116 can be refilled. In other examples, the heater unit 102 can be a component of the vapour generation device, and the reservoir 116 (and optionally the wicking material 114) can form a removable component that can be detached from the vapour generation device (such as when the reservoir 116 is empty of liquid).

Further details of the structure of the heater unit 102, in particular the through-channels 108, will now be discussed.

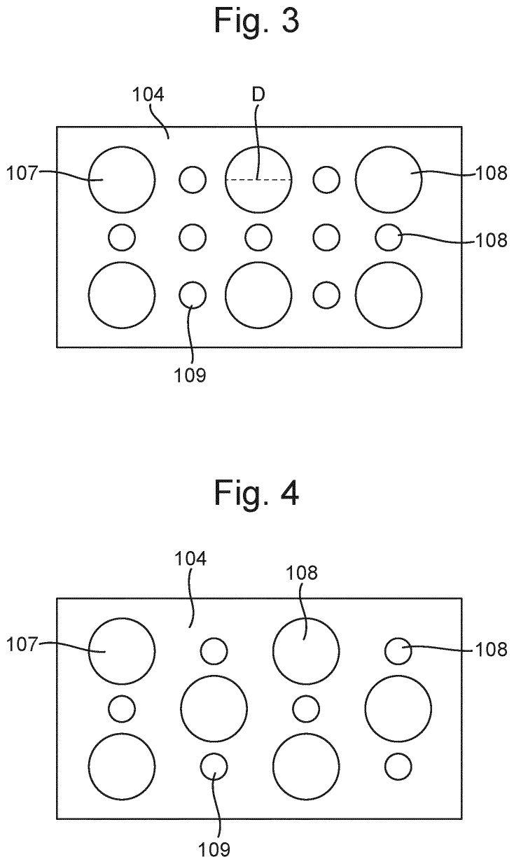

The plurality of through-channels 108 comprise a number of primary through-channels 107 and a number of secondary through-channels 109. In some cases there may be one primary through-channel and one secondary through-channel. In preferred examples, there are at least two primary through-channels 107 and at least two secondary through-channels 109, as can be seen in FIG. 3.

The primary through-channels 107 have a diameter that is different to a diameter of the secondary through-channels 109, and in the example shown in FIG. 3 the primary through-channels 107 have a diameter that is greater than a diameter of the secondary through-channels 109. Said another way, the primary through-channels 107 are bigger than the secondary through-channels 109. It should be noted that the term diameter does not necessarily mean that the through-channels 108 are circular in cross-section. Instead, diameter is used to refer to a distance D between one side of a through-channel 108 and an opposing side on the same through-channel 108, for example a width or length.

Each through-channel 108 has a constant cross-section from the first opening 110 to the second opening 112 and so the diameter of each through-channel 108 is constant along the length of the through-channel 108. That is, the diameter of the first opening 110 of a through-channel 108 is the same as the diameter of the second opening 112 of the same through-channel 108.

In the illustrated example of FIG. 3, all the primary through-channels 107 have the same diameter and all the secondary through-channels have the same diameter. The plurality of through-channels 108 can therefore be thought of as comprising two groups or sets of through-channels, wherein each set of through-channels has a different diameter.

In some cases, all the through-channels within a set are the same. For example a first set may comprise all the primary through-channels 107 and the diameter of each of the primary through-channels 107 may be the same, and a second set may comprise all the secondary through-channels 109 and the diameter of each of the secondary through-channels 109 may be the same (with the diameters of each set being different, as explained above).

However, in other cases, all the through-channels within a set may be different from each other. For example a first set may comprise all the primary through-channels 107 and the diameter of each of the primary through-channels 107 may be different from each other, and a second set may comprise all the secondary through-channels 109 and the diameter of each of the secondary through-channels 109 may be different from each other. In this case, whilst the diameters of the through-channels 108 within a set may be different from each other, it would still be the case that all of the through-channels 108 within one set was greater than all the through-channels 108 within the other set. Thus, it would still be the case that the primary through-channels 107 have a diameter that is greater than the secondary through-channels 109.

In a similar manner, in some cases all the through-channels 108 within a set may have the same shaped cross-section. For example a first set may comprise all the primary through-channels 107 and the shape of each cross-section of the primary through-channels 107 may be the same, and a second set may comprise all the secondary through-channels 109 and the shape of each cross-section of the secondary through-channels 109 may be the same.

In the example of FIG. 3, all the primary through-channels 107 have a substantially circular cross-section and all the secondary through-channels 109 have a substantially circular cross-section. Here, all the through-channels 108 have the same shaped-cross section. That is, the first and second set have the same shaped cross-section. However, the first and second sets may have cross-sections that are different from each other. For example the first set could be substantially circular and the second set could be substantially square.

Similarly, in other cases, all the through-channels 108 within a set may have cross-sections that are different shapes from each other. For example a first set may comprise all the primary through-channels 107 and the shape of each cross-section of the primary through-channels 107 may be different from each other, and a second set may comprise all the secondary through-channels 109 and the shape of each cross-section of the secondary through-channels 109 may be different from each other.

As discussed, the first opening 110 of each through-channel 108 is located within the first surface 104 of the heater unit 02, which is also the heating surface of the heater unit 102, and so the through-channels 108 are arranged on the heating surface and form part of the heating surface of the heater unit 102.

The through-channels 108 are arranged across substantially the entire first surface of the heater unit 102. In particular the through-channels 108 are arranged such that the primary through-channels 107 are alternately arranged with the secondary through-channels 109. By an alternating arrangement, we mean that a primary through-channel 107 is positioned next to at least one secondary through-channel 109, instead of being positioned next to only other primary through-channels 107, and vice versa in relation to secondary through-channels 109.

FIGS. 3 and 4 show two examples of alternately arranged primary and secondary through-channels 108. Looking at FIG. 3, the alternate arrangement can be considered as regular. For example, FIG. 3 shows primary and secondary through-channels alternately arranged in a regular grid-like pattern. Whilst this arrangement shows more secondary through-channels 109 than primary through-channels 107, in other arrangements there could be more primary through-channels 107 than secondary through-channels 109, or the same number of primary and secondary through-channels as shown in FIG. 4. Thus, the number of primary through-channels 107 does not have to be the same as the number of secondary through channels 109, but in some cases they are the same.

In other examples the alternative arrangement can be considered as irregular. By irregular, we mean that the through-channels are positioned substantially randomly across the first surface of the heater unit and do not conform to a typical pattern or structure. Although irregularly arranged, the primary and secondary through-channels 108 would still be alternately arranged in relation to each other.

The through-channels provide a filtering function, acting to filter the generated vapour as it flows from the heater unit 102 into the airflow channel 128. This is because the different channels sizes, namely the primary and secondary through-channels, can selectively pass liquids with different fluid properties from the reservoir through the heater unit 102 via the through-channels 108, mainly due to different surface tensions of these liquids.

The surface tension of the liquid allows the liquid to rise, or flow, through each through-channel 108 via capillary action. Vaporization of the liquid within the through-channel 108 occurs when the liquid has travelled sufficiently far along the length of the through-channel 108.

The height that the liquid will rise to within a through-channel 108, under capillary action is given by the following relationship:

$$h = \frac{2 γ cos θ}{ρ g r} , \qquad Eq . 1$$

where γ is the liquid-air surface tension (force/unit length), θ is the contact angle, ρ is the density of the liquid (mass/volume), g is the local acceleration due to gravity (length/square of time), and r is the radius of the through-channel. Thus, the thinner, the through-channel in which the liquid can travel, the further up the through-channel it travels.

Different vapor-generating liquids typically have different surface tensions, contact angles, and density values and so, in accordance with Eq. 1 above, will rise to different heights within a given through-channel 108. Selective passage of liquids through the though-channels 108 can therefore be achieved by making the through-channel height greater or less than an effective height for vaporization, for a given radius of through-channel. This selection effect can also be achieved by adjusting the radius of the through-channel for a given height. Thus, in the case of the present disclosure, the different sized primary and secondary through-channels 108 provide the selective passage of liquids through the heater unit 102.

Thus, having a heater unit 102 comprising a plurality of through-channels 108 of different diameters means that a particular through-channel diameter can be used to selectively pass a liquid of a specific surface tension through the through-channels 108. This can be achieved by optimally sizing each through-channel 108 for use with a particular liquid type, having a particular surface tension. The heater unit 102 can therefore be thought of as a universal heater unit.

Advantageously, the different through-channel sizes, namely the primary and secondary through-channels, allow a greater range of liquid surface tensions to be vaporised by the same heater unit 102. This results in a more efficient heater unit 102 because it is able to function with a greater range of liquids that can be stored in the reservoir 116. That is to say, one heater unit 102 can be used with multiple different liquids. The through-channels 108 having different channel diameters are distributed across a single heater unit 102, increasing the versatility of the heater unit 102.

A further advantage of the heater unit is that the presence of the larger diameter through-channels also has the effect of reduced resistance-to-flow of the liquid, which allows for a sufficient amount of liquid supply (mainly through the larger channels) even when the heater temperature is still low and the liquid viscosity remains high (i.e. at an initial stage of heater operation). It is understood that a higher viscosity liquid receives a greater friction force as it travels through the through-channels. This means that movement of the high viscosity liquid tends to be slow until it is heated up and its viscosity is reduced, resulting in limited amounts of liquid supply for vaporization at an initial stage of heater operation. However the combination of the large and small through-channels contributes to suitable amounts of liquid supply especially for the high viscosity liquid, throughout the heater unit operation period i.e. both at initial and later stages.

1. A heater device for an electronic cigarette comprising:
a heater unit arranged to vaporise a liquid received from a liquid reservoir and generate a vapour;
a vapour flow path extending from the heater unit, the vapour flow path arranged to fluidly communicate with a mouthpiece of an electronic cigarette to allow the generated vapour to flow from the heater unit to the mouthpiece;
wherein the heater unit comprises a plurality of through-channels arranged to allow the generated vapour to flow from the heater unit to the vapour flow path;
wherein the plurality of through-channels comprises at least two primary through-channels and at least two secondary through-channels;
wherein a diameter of a primary through-channel is different than a diameter of a secondary through-channel;
wherein the plurality of through-channels are arranged such that the at least two primary through-channels are alternately arranged with the at least two secondary through-channels; and
wherein the heater unit is arranged to heat the liquid through sidewalls of the plurality of through-channels, as the liquid is drawn through the through-channels, to generate the vapour.

2. The heater device according to claim 1 wherein the plurality of through-channels form part of the vapour flow path.

3. The heater device according to claim 1 wherein the plurality of through-channels act as a filter arranged to filter the generated vapour as it flows from the heater unit to the vapour flow path.

4. The heater device according to claim 1 wherein the diameters of all of the primary through-channels are the same as one another.

5. The heater device according to claim 1 wherein the diameters of all the secondary through-channels are the same as one another.

6. The heater device according to claim 1 wherein the diameters of all of the primary and secondary through-channels of the plurality of through-channels are all different from each other.

7. The heater device according to claim 1 wherein the diameters of the at least two primary through-channels are greater than the diameters of the at least two secondary through-channels.

8. The heater device according to claim 1 wherein the heater unit comprises a capillary portion and a heating surface wherein:
the capillary portion is located between the liquid reservoir and the heating surface, the capillary portion being arranged to transfer liquid from the liquid reservoir to the heating surface;
the heating surface is arranged to heat the received liquid and generate a vapour.

9. The heater device according to claim 8 wherein the plurality of through-channels form part of the heating surface.

10. The heater device according to claim 9 wherein the plurality of through-channels are arranged across substantially the entire heating surface.

11. The heater device according to claim 9 wherein the plurality of through-channels are arranged in a regular pattern on the heating surface.

12. The heater device according to claim 9 wherein the plurality of through-channels are arranged in an irregular pattern on the heating surface.

13. The heater device according to claim 1 wherein the at least two primary through-channels and the at least two secondary through-channels have the same shape.

14. The heater device according to claim 1 wherein the at least two primary through-channels and the at least two secondary through-channels have different shapes.

15. The heater device according to claim 1 wherein the at least two primary through-channels and/or the at least two secondary through-channels is substantially circular.

16. The heater device according to claim 1, wherein the at least two primary through-channels and the at least two secondary through-channels are configured to selectively pass liquids from the heater unit to the vapour flow path.

17. The heater device according to claim 1, wherein the at least two primary through-channels and the at least two secondary through-channels are configured to selectively pass liquids having different fluid properties from the heater unit to the vapour flow path.

18. The heater device according to claim 1, wherein the at least two primary through-channels and the at least two secondary through-channels are configured to selectively pass liquids having different surface tensions from the heater unit to the vapour flow path.

19. A capsule for an electronic cigarette, the capsule having a first end configured to engage with an electronic cigarette device and a second end arranged as a mouthpiece portion having a vapour outlet, the capsule further comprising:
a liquid reservoir arranged to store a liquid to be vaporised;
a heater unit arranged to vaporise the liquid received from the liquid reservoir and generate a vapour;
a vapour flow path extending from the heater unit, the vapour flow path arranged to fluidly communicate with a mouthpiece of an electronic cigarette to allow the generated vapour to flow from the heater unit to the mouthpiece;
wherein the heater unit comprises a plurality of through-channels arranged to allow the generated vapour to flow from the heater unit to the vapour flow path;
wherein the plurality of through-channels comprises at least two primary through-channels and at least two secondary through-channels, and further wherein a diameter of a primary through-channel is different than a diameter of a secondary through-channel;
wherein the plurality of through-channels are arranged such that the at least two primary through-channels are alternately arranged with the at least two secondary through-channels; and
wherein the heater unit is arranged to heat the liquid through sidewalls of the plurality of through-channels, as the liquid is drawn through the through-channels, to generate the vapour.

20. An electronic cigarette comprising a main body and a capsule wherein the main body comprises a power supply unit, electrical circuitry, and a capsule seating configured to connect with the capsule, the capsule comprising:
a first end configured to engage with the electronic cigarette device and a second end arranged as a mouthpiece portion having a vapour outlet, the capsule further comprising:
a liquid reservoir arranged to store a liquid to be vaporised;
a heater unit arranged to vaporise the liquid received from the liquid reservoir and generate a vapour;
a vapour flow path extending from the heater unit, the vapour flow path arranged to fluidly communicate with a mouthpiece of an electronic cigarette to allow the generated vapour to flow from the heater unit to the mouthpiece;
wherein the heater unit comprises a plurality of through-channels arranged to allow the generated vapour to flow from the heater unit to the vapour flow path;
